(19) United States
(12) Patent Application Publication
(10) Pub. No.: US 2022/0145560 A1
(43) Pub. Date: May 12, 2022

(54) Double-Handle Snow Shovel

(71) Applicant: Peter John Ziamandanis, Albany, NY (US)

(72) Inventor: Peter John Ziamandanis, Albany, NY (US)

(21) Appl. No.: 17/580,397

(22) Filed: Jan. 20, 2022

Related U.S. Application Data
(63) Continuation-in-part of application No. 16/188,710, filed on Nov. 13, 2018, now Pat. No. 11,266,288.
Application No. 16/188,710 is a continuation-in-part of application No. 16/042,291, filed on Jul. 23, 2018, now abandoned.
(60) Provisional application No. 62/630,933, filed on Feb. 15, 2018.

(51) Int. Cl. E01H 5/02; A01B 1/02

(52) U.S. Cl. CPC E01H 5/02; A01B 1/026

(57) ABSTRACT

A double-handle snow shovel includes a snow shovel-head apparatus, an extension tube, a support shaft, a bend shaft, and a handle. The support and bend shaft are collectively optimized leverage to apply pressure to accumulated snow, without having to bend over. The bend shaft includes a first elongated section, a second elongated section, and a bend section as the bend shaft is formed into a V-shaped body. The first elongated section is terminally connected to a first shaft end of the support shaft. The second elongated section is terminally connected to a second shaft end of the support shaft. The first and second elongated sections are terminally connected to each other by the bend section, opposite the support shaft. The first shaft end is mounted to the snow shovel-head apparatus by the extension tube. The second shaft end is adjacently connected with the handle that engages with the user.

The current application is a continuation-in-part (CIP) application of a U.S. non-provisional application Ser. No. 16/188,710 filled on Nov. 13, 2018. The U.S. non-provisional application Ser. No. 16/188,710 claim priority to a U.S. non-provisional application Ser. No. 16/042,291 filed on Jul. 23, 2018. The U.S. non-provisional application Ser. No. 16/042,291 claims a priority to a U.S. provisional application Ser. No. 62/630,933 filed on Feb. 15, 2018.

### FIELD OF THE INVENTION

The present invention relates generally to a shovel. More specifically, the present invention is a double-handle snow shovel that enables a user to remove snow accumulations without having to bend over to place the shovel against the ground surface.

### BACKGROUND OF THE INVENTION

Every winter, cities around the world are covered in snow. While children may enjoy making snowmen and having snowball fights, adults need to remove snow from their properties in order to drive and function in daily life. Snow comes in a variety of forms that occasionally makes it very difficult for the user to remove. Particularly when it rains before snowing, the resulting agglomerations of wet snow are heavy and difficult to move. To this end, a variety of shovels and plows have been developed to remove the snow. However, snowplows can be expensive, and necessarily require fuel or attachment vehicles. Snow blowers too can be pricy and difficult to store in many garages. Standard shovels can cause injuries due to awkward usage. Shovels generally just have one handle and one support connected to the head. The user is meant to grasp the handle with one hand and grasp the support with the other hand. The design of almost all shovels requires the operator to use the shovel while bending over, which is not conducive to protecting the user's back. Resultantly, there is a need for a device that is easy to use and maintain, while simultaneously ensuring there is no related stress to the user's back. What is further needed is a device that enables the user to support the shovel with both hands while standing in a complete upright position.

It is therefore an object of the present invention to provide a double-handle snow shovel that provide two places for gripping. The first handle is positioned similar to the existing handle position of most shovels. The second handle is a bent handle that forms a V-shaped body. The second handle has two ancillary supports located proximally connected to the first handle as the two ancillary supports are connected to each other by a bend section. The section handle enables the user to grasp the snow shovel from two gripping positions (two ancillary supports), thus allowing the user to utilize the present invention without bending over at the waist or spine to pick up and throw snow. An upright position prevents the user from worrying about damage to the user's back or body during use, while further allowing optimal leverage for lifting and subsequently removing snow.

### BRIEF DESCRIPTION OF THE DRAWINGS

FIG. 1 is a front perspective view of the present invention.

FIG. 2 is a rear perspective view of the present invention.

FIG. 3 is a side view of the present invention, showing the curved body of the support shaft.

FIG. 4 is a side view of the present invention, showing the acute angle between the first elongated section and the second elongated section.

FIG. 5 is an exploded front perspective view of the present invention.

FIG. 6 is a front view of the snow shovel-head apparatus of the present invention.

### DETAIL DESCRIPTIONS OF THE INVENTION

All illustrations of the drawings are for the purpose of describing selected versions of the present invention and are not intended to limit the scope of the present invention.

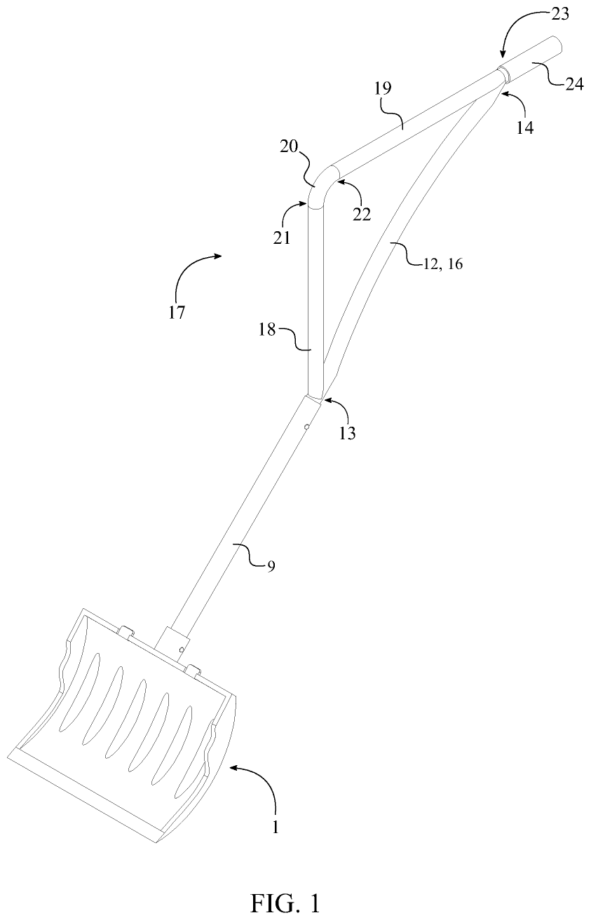

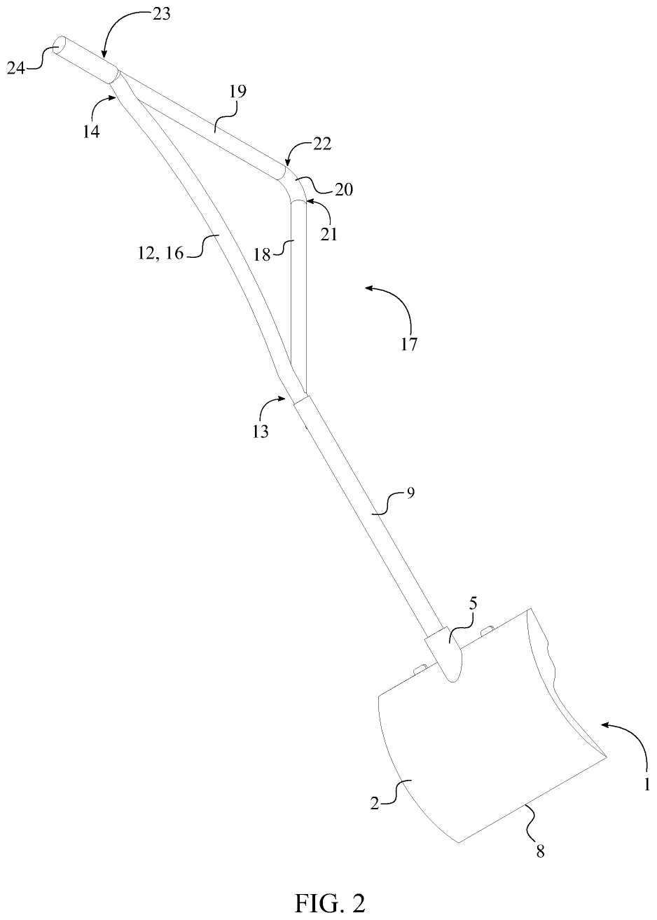

The present invention is a shovel that enables the user to remove accumulated snow without having to bend over to place the shovel against the ground surface. The components and their configuration of the present invention enable the user to accomplish abovementioned tasks without having to bend over at the waist or body during usage. The present invention comprises a snow shovel-head apparatus 1, an extension tube 9, a support shaft 12, a bend shaft 17, a handle 23 as shown in FIG. 1-2. The bend shaft 17 enables the user to keep a straight back during usage and comprises a first elongated section 18, a second elongated section 19, and a bend section 20. In reference to the general configuration of the present invention as shown in FIG. 1-3, the support shaft 12 and the bend shaft 17 are connected to each other delineating a triangular profile for the combination of two shafts. The snow shovel-head apparatus 1 is terminally connected to the support shaft 12 from one end. The handle 23 is terminally connected to the support shaft 12 and positioned opposite of the snow shovel-head apparatus 1 thus completing the general configuration of the present invention.

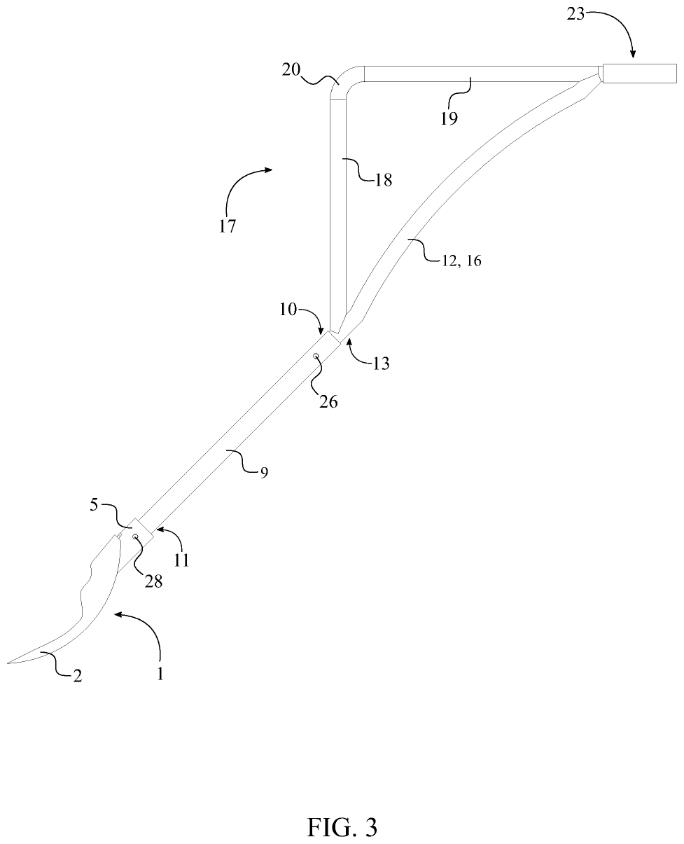

The support shaft 12 functions as the base member within the present invention as the support shaft 12 allows the snow shovel-head apparatus 1 and the handle 23 to be mounted from each end. Furthermore, the support shaft 12 stabilizes the bend shaft 17 and eliminates any elastic deformation that can occur due the added weight of the cleaning pressure. The bend shaft 17 allows the user to grasp the present invention during usage so that the user can maintain a straight back. In reference to FIG. 3, the first elongated section 18 is terminally connected to a first shaft end 13 of the support shaft 12 so that the bend shaft 17 can be connected from one end. The second elongated section 19 is terminally connected to a second shaft end 14 of the support shaft 12 so that the bend shaft 17 can be connected from the opposite end. The bend section 20 is then able to connect the first elongated section 18 and the second elongated section 19 thus completing the overall structure between the support shaft 12 and the bend shaft 17. More specifically, the first elongated section 18 is terminally connected to a first end 21 of the bend section 20, opposite of the first shaft end 13. The second elongated section 19 is terminally connected to a second end 22 of the bend section 20, opposite of the second shaft end 14. Resultantly, the support shaft 12 and the bend shaft 17 are able to complete the triangular profile of the present invention while the bend section 20, the first shaft end 13, and the second shaft end 14 generally delineate the corners of the triangular profile.

In a preferred embodiment of the present invention, the support shaft 12 is a curved body 16 from the first shaft end 13 to the second shaft end 14 as shown in FIG. 3. Furthermore, a convex side of the curved body 16 is oriented towards the bend shaft 17. In an alternative embodiment of the present invention, the support shaft 12 can be a straight body from the first shaft end 13 to the second shaft end 14. The straight body and the curved body 16 provide an aesthetical difference between each embodiment. However, both the straight body and the curved body 16 maintain the same structural integrity within the present invention to eliminate any elastic deformation that may otherwise occur within the bend shaft 17.

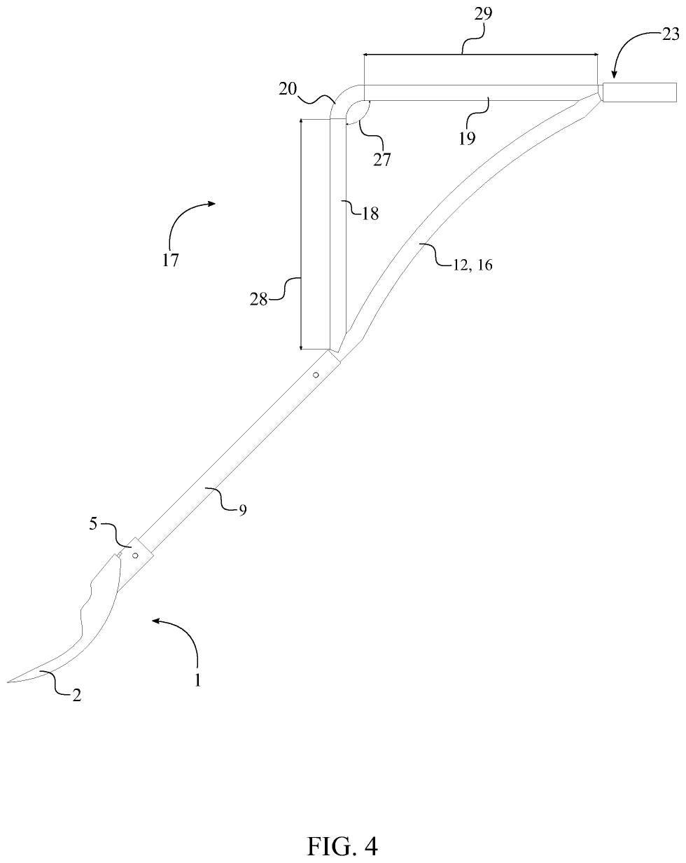

In reference to FIG. 4, the first elongated section 18 and the second elongated section 19 delineate an acute angle 27 about the bend section 20. Preferably, the acute angle 27 can be measured in degrees within the present invention. In reference to FIG. 4, a length 28 of the first elongated section 18 is preferably equal to a length 29 of the second elongated section 19. However, the length 28 of the first elongated section 18 can also be longer or shorter to the length 29 of the second elongated section 19 with respect to different embodiment of the present invention. Collectively, the acute angle 27 and the equal length between the first elongated section 18 and the second elongated section 19 position the bend section 20 in line with the handle 23 when the snow shovel-head apparatus 1 is positioned flat against a floor. As a result, the user can comfortably grasp the handle 23 and the bend section 20 or the second elongated section 19 during the usage of the present invention without having to bend down. In other words, the user can grasp the handle 23 with one hand thus partially securing the present invention. The user can then fully secure the present invention by grasping the bend section 20 or the second elongated section 19 with the other hand. Since the bend section 20 is positioned in line with the second shaft end 14, the user can simply extend their arm and grasp the bend section 20 or the second elongated section 19 without having to bend down.

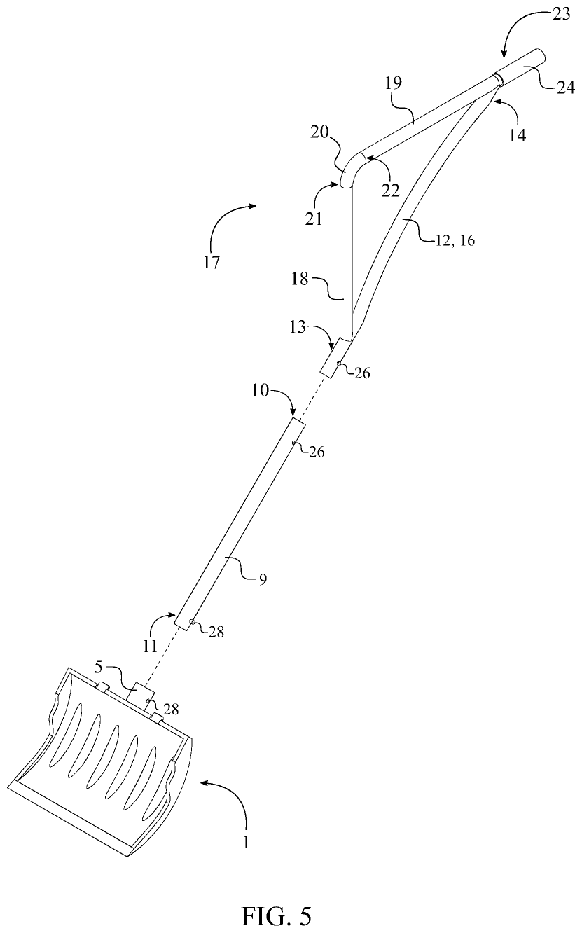

In reference to FIG. 5, the first shaft end 13 is mounted to the snow shovel-head apparatus 1 by the extension tube 9 so that the support shaft 12 and the snow shovel-head apparatus 1 can be secured within the present invention. More specifically, a proximal end 10 of the extension tube 9 of and the first shaft end 13 are concentrically mounted to each other by a first fastener 26 so that the extension tube 9 can be detached from the support shaft 12 when necessary. As a result of the removable attachment between the first shaft end 13 and the extension tube 9, the user can adjust the length between the first shaft end 13 and the shovel-head apparatus 1 by interchanging extension tubes 9 that are in different lengths. A distal end 11 of the extension tube 9 and a collar 5 of the snow shovel-head apparatus 1 are concentrically mounted to each other by a second fastener 28 so that the snow shovel-head apparatus 1 can be detached from the extension tube 9 when necessary. As a result of the removable attachment between the extension tube 9 and the first shaft end 13 and the snow shovel-head apparatus 1, the user can interchange with multiple snow shovel-head apparatus 1 that are different in width, shape, or material to encompass different types of cleaning purposes. Additionally, when an old snow shovel-head apparatus 1 is worn out and unusable, the worn-out snow shovel-head apparatus 1 can be changed into a new snow shovel-head apparatus 1 through the second fastener 28.

The present invention preferably utilizes a spring loaded button fastener that is integrated into the first shaft end 13 and a corresponding opening that traverses through the extension tube 9 as the first fastener 26. Similarly, the present invention preferably utilizes a spring loaded button fastener that is integrated into the extension tube 9 and a corresponding opening that traverses through the collar 5 as the second fastener 28. However, the first fastener 26 and the second fastener 28 are not limited to the preferred fastening mechanism and can include, but is not limited to, a screw fastener, a male and female treaded fastener, a clamp fastener, a snap fastener, and a latch fastener.

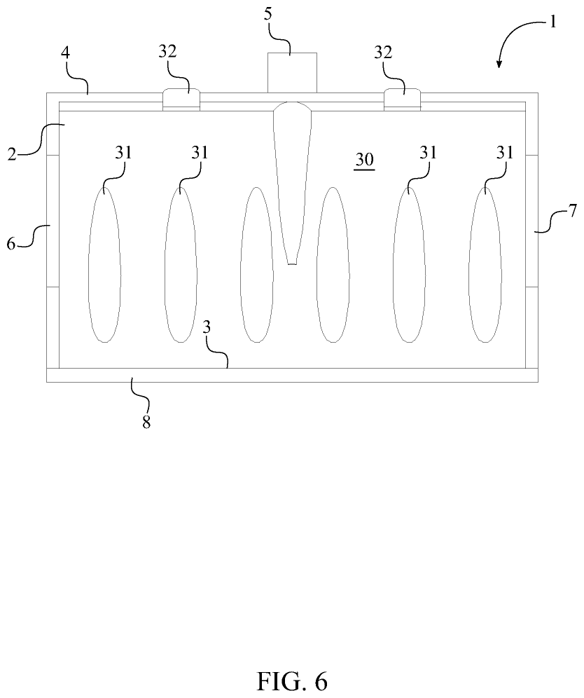

The snow shovel-head apparatus 1 functions similar to existing shovel heads so that snow can be collected and moved within the present invention. In reference to FIG. 6, the snow shovel-head apparatus 1 further comprises a blade 2, a first lateral wall 6, a second lateral wall 7, a scraper edge 8 in addition to the collar 5. The collar 5 is a cylindrical sleeve body and adjacently connected to a rear edge 4 of the blade 2 so that the distal end 11 of the extension tube 9 can be inserted into the collar 5. The scraper edge 8 is a shape/rigid body, preferably metal reinforced edge, so that the user can easily brake or chop ice or dig into the snow. The scraper edge 8 is adjacently connected to a front edge 3 of the blade 2 so that the scraper edge 8 can provide the initial contact with snow during usage of the present invention. As a result, the scraper edge 8 and the collar 5 are oppositely positioned of each other about the blade 2 as the snow is generally pushed forward by the user. The first lateral wall 6 is terminally connected along the blade 2 to prevent snow from falling off the side of the blade 2. The second lateral wall 7 is terminally connected along the blade 2 and positioned opposite of the first lateral wall 6 to prevent snow from falling off the opposite side of the blade 2. More specifically, the first lateral wall 6 and the second lateral wall 7 are extended from the rear edge 4 to the front edge 3 so that the arrangement of the first lateral wall 6 and the second lateral wall 7 enable the user to keep snow on top of the blade 2.

In reference to FIG. 6, the snow shovel-head apparatus 1 further comprises a plurality of grooves 31 as the plurality of grooves 31 is linearly extended along an inner surface 30 of the blade 2. The plurality of grooves 31 is a set of channels that is generally arranged in a linear pattern extending along the blade 2 so that the snow can break apart and contain within the blade 2 thus preventing lateral movement during the usage of the present invention. In other words, the plurality of grooves 10 is extended vertically from the front edge 3 of the blade 2 to the rear edge 4 of the blade 2 as each of the plurality of grooves 10 is equally spaced apart from each other in between the first lateral wall 6 and the second lateral wall 7.

In reference to FIG. 6, the snow shovel-head apparatus 1 further comprises a pair of stacking supports 32 so that the present invention can store within a limited amount of space for convenience by offsetting them from each other. More specifically, the pair of stacking supports 32 is connected along the rear edge 4 as the collar 5 is symmetrically positioned in between the pair of stacking supports 32. As a result, the user can arrange multiple embodiments of the present invention to the right side and the left side of the first embodiment, thus efficiently maximizing the space.

In reference to FIG. 1-2, the second shaft end 14 is adjacently connected to the handle 23 so that the support shaft 12 and the handle 23 can be secured within the present invention. The present invention further comprises a gripping body 24 as the gripping body 24 is externally connected around the handle 23. More specifically, the gripping body 24 provides ergonomic surface area to grasp the handle 23 so that the friction between the handle 23 and the user's hand can be enhanced. Furthermore, the overall shape of the gripping body 24 is determined upon the shape of the handle 23 due to the fact that the gripping body 24 fully encloses the handle 23. Preferably, the handle 23 is formed into an elongated body. However, the handle 23 can also be formed into an industry standard D-shaped handle.

The present invention may further comprise a grip to enhance the friction between the user's hand and the bend section 20 or the second elongated section 19. The grip is a generally flexible, preferably rubber or foam extrusion that wraps around the bend section 20 or the second elongated section 19.

Although the invention has been explained in relation to its preferred embodiment, it is to be understood that many other possible modifications and variations can be made without departing from the spirit and scope of the invention as hereinafter claimed.

What is claimed is:

1. A double-handle snow shovel comprising:
a snow shovel-head apparatus;
an extension tube;
a support shaft;
a bend shaft;
a handle;
the bend shaft comprising a first elongated section, a second elongated section, and a bend section;
the first elongated section being terminally connected to a first shaft end of the support shaft;
the second elongated section being terminally connected to a second shaft end of the support shaft;
the first elongated section being terminally connected to a first end of the bend section, opposite of the first shaft end;
the second elongated section being terminally connected a second end of the bend section, opposite of the second shaft end;
the first shaft end being mounted to the snow shovel-head apparatus by the extension tube;
the second shaft end being adjacently connected to the handle; and
the support shaft being a curved body.

2. The double-handle snow shovel as claimed in claim 1 comprising:
the snow shovel-head apparatus comprising a blade, a collar, a first lateral wall, a second lateral wall, and a scraper edge;
the collar being adjacently connected to a rear edge of the blade;
the scraper edge being adjacently connected along a front edge of the blade;
the scraper edge and the collar being oppositely positioned of each other about the blade;
the first lateral wall being terminally connected along the blade;
the second lateral wall being terminally connected along the blade, opposite of the first lateral wall; and
the first lateral wall and the second lateral wall being extend from the rear edge to the front edge.

3. The double-handle snow shovel as claimed in claim 1 comprising:
the snow shovel-head apparatus further comprising a plurality of grooves; and
the plurality of grooves being linearly extended along an inner surface of the blade.

4. The double-handle snow shovel as claimed in claim 1 comprising:
the snow shovel-head apparatus further comprising a pair of stacking supports;
the pair of stacking supports being connected along a rear edge of the blade; and
the collar being symmetrically positioned in between the pair of stacking supports.

5. The double-handle snow shovel as claimed in claim 1 comprising:
the snow shovel-head apparatus comprising a collar;
a proximal end of the extension tube being concentrically mounted to the first shaft end; and
a distal end of the extension tube being concentrically mounted to the collar.

6. The double-handle snow shovel as claimed in claim 5 comprising:
a first fastener; and
the proximal end of the extension tube and the first shaft end being mounted to each other by the first fastener.

7. The double-handle snow shovel as claimed in claim 5 comprising:
a second fastener; and
the collar and the distal end of the extension tube being mounted to each other by the second fastener.

8. The double-handle snow shovel as claimed in claim 1 comprising:
a gripping body; and
the gripping body being externally connected around the handle.

9. The double-handle snow shovel as claimed in claim 1, wherein the first elongated section and the second elongated section delineate an acute angle about the bend section.

10. A double-handle snow shovel comprising:
a snow shovel-head apparatus;
an extension tube;
a support shaft;
a bend shaft;
a handle;
the bend shaft comprising a first elongated section, a second elongated section, and a bend section;
the first elongated section being terminally connected to a first shaft end of the support shaft;
the second elongated section being terminally connected to a second shaft end of the support shaft;
the first elongated section being terminally connected to a first end of the bend section, opposite of the first shaft end;
the second elongated section being terminally connected a second end of the bend section, opposite of the second shaft end;
the first shaft end being mounted to the snow shovel-head apparatus by the extension tube;
the second shaft end being adjacently connected to the handle;
the support shaft being a curved body; and
an acute angle being delineated between the first elongated section and the second elongated section about the bend section.

11. The double-handle snow shovel as claimed in claim 10 comprising:
the snow shovel-head apparatus comprising a blade, a collar, a first lateral wall, a second lateral wall, and a scraper edge;
the collar being adjacently connected to a rear edge of the blade;
the scraper edge being adjacently connected along a front edge of the blade;
the scraper edge and the collar being oppositely positioned of each other about the blade;
the first lateral wall being terminally connected along the blade;
the second lateral wall being terminally connected along the blade, opposite of the first lateral wall; and
the first lateral wall and the second lateral wall being extend from the rear edge to the front edge.

12. The double-handle snow shovel as claimed in claim 10 comprising:
the snow shovel-head apparatus further comprising a plurality of grooves; and
the plurality of grooves being linearly extended along an inner surface of the blade.

13. The double-handle snow shovel as claimed in claim 10 comprising:
the snow shovel-head apparatus further comprising a pair of stacking supports;
the pair of stacking supports being connected along a rear edge of the blade; and
the collar being symmetrically positioned in between the pair of stacking supports.

14. The double-handle snow shovel as claimed in claim 10 comprising:
the snow shovel-head apparatus comprising a collar;
a proximal end of the extension tube being concentrically mounted to the first shaft end; and
a distal end of the extension tube being concentrically mounted to the collar.

15. The double-handle snow shovel as claimed in claim 14 comprising:
a first fastener; and
the proximal end of the extension tube and the first shaft end being mounted to each other by the first fastener.

16. The double-handle snow shovel as claimed in claim 14 comprising:
a second fastener; and
the collar and the distal end of the extension tube being mounted to each other by the second fastener.

17. The double-handle snow shovel as claimed in claim 10 comprising:
a gripping body; and
the gripping body being externally connected around the handle.
